(19) United States
(12) Patent Application Publication
(10) Pub. No.: US 2002/0091563 A1
(43) Pub. Date: Jul. 11, 2002

(54) Company diagnosis system, company diagnosis method and company diagnosis server, and storage medium therefor

(75) Inventor: Sakae Wasa, Ohtsu-shi (JP)

Correspondence Address: A. Bruce Clay, IBM Corporation T81/503, P.O. Box 12195, Research Triangle Park, NC, 27709, US

(73) Assignee: International Business Machines Corporation, Armonk, NY (US)

(21) Appl. No.: 09/960,917

(22) Filed: Sep. 21, 2001

(30) Foreign Application Priority Data
Sep. 22, 2000 (JP) 2000-288658

(51) Int. Cl. G06F 17/60

(52) U.S. Cl. 705/10

(57) ABSTRACT

The present invention uses a server 3 comprising means for having a questionnaire QA being displayed via a network 1, means for receiving a reply to the questionnaire QA via the network 1, means for processing the received reply to the questionnaire using data stored in first and second databases DB1 and DB2 to produce processed reply data, means for having the processed reply data being displayed by a computer 2, and means for updating the second database DB2 by storing the processed reply data in the second database DB2.

### FIELD OF THE INVENTION

The present invention relates to providing value-added information as a result of processing questionnaires, and more particularly to a company diagnosis system for providing value-added information concerning the reliability of a company or enterprise by processing questionnaires, a company diagnosis server for performing such company diagnosis, a company diagnosis method for performing such company diagnosis, and a computer-readable storage medium therefor.

### BACKGROUND ART

In today's networked society, many companies or enterprises fulfill their duties in various value chains, and perform a variety of activities while maintaining dynamic and complicated relationships between the companies. Under such conditions, credibility and soundness of the companies become more important as indication of company reliability. Therefore, large companies would be required to improve their company reliability by objectively understanding and evaluating the company reliability and taking measures depending on the evaluation results. Furthermore, in the atomic, waste disposal, food and medical industries, for example, which may have great influence on the environment, society and human life, it is necessary not only for large companies but also for small companies to objectively increase their company reliability since once an accident has occurred, a great impact would be made on society.

However, even when company reliability is to be objectively judged, many companies may not have enough information accumulated to serve as a basis for precisely evaluating and understanding their company reliability. Also, some companies may not sufficiently establish know-how on the technique for objectively evaluating the company reliability, which would result in varied evaluation for soundness and credibility of the companies and would raise a doubt on reliability of the evaluation per se, and, therefore, a satisfactory evaluation is not always performed. Note that the company reliability used herein includes legal and social credibility and soundness of a company.

Therefore, it is considered that business opportunities for reliable consultations on the company reliability are potentially high. However, it has been difficult to expand the business opportunities for the consultations whose orders are received through conventional business channels because reliability and effectiveness of a consultation would be doubtful due to, for example, user's inexperience, insufficient mutual understanding at the time of the consultation, personal nature of a consultant, or reflection of user's intent in the understanding leading to lack of objectivity in the consultation.

The reliability of consultation may be improved without being affected by the nature of consultants if a computer is used for the consultation in the form of questionnaires. However, it is anticipated that the average reaction of companies to a criterion of judgment that is the subject of consultation will change with the lapse of time in accordance with the social conditions. Thus, when a computer system is used for the consultation, data stored in a database for determining the company reliability must be improved in accordance with the social environment existing at the time of the consultation, otherwise reliability of the consultation tends to be reduced. Therefore, there is a need for more reliable consultation using a computer system.

Therefore, it is necessary for companies whose business processes should be improved to easily and accurately evaluate soundness and credibility of their business processes, and to fully understand any issue to be resolved. It is also necessary to motivate effectiveness and necessity of the consultation based on the understanding, and to have a consultation for the business processes based on sufficient technical foundations. Furthermore, required is a company diagnosis associated with a consultation, capable of improving accuracy of the consultation while conducting the consultation to improve company reliability, and supporting improvement of legal and social credibility and soundness of a company with high reliability.

### SUMMARY OF THE INVENTION

In view of the above, the present invention provide a company diagnosis system comprising means for having a questionnaire being displayed via a network, means for receiving a reply to said questionnaire via said network, means for processing said received reply to the questionnaire using data stored in first and second databases to produce processed reply data, means for having said processed reply data being displayed, and means for updating said second database by storing said processed reply data in said second database.

In the present invention, said questionnaire is stored in said first database, and, in order to update said second database, processed reply data obtained by processing a reply to a free questionnaire that is a part of said questionnaire stored in said first database, or processed reply data obtained by processing a reply to a charged questionnaire that includes all question items of said questionnaire stored in said first database are stored in said second database.

In the present invention, said reply to said questionnaire is changed to numerical data using the data in said first database, and said numerical data are ranked using the data stored in said second database to obtain said processed reply data.

In the present invention, said first database further stores point data associated said reply to said questionnaire. In the present invention, question items in said questionnaire are sorted into categories of company reliability, and said system further comprises means for selecting and accumulating, for each category of said company reliability, the point data corresponding to replies to said question items. In the present invention, said processed reply data constitute consultation information concerning company reliability.

The present invention further provides a company diagnosis server comprising means for having a questionnaire being displayed via a network, means for receiving a reply to said questionnaire via said network, means for processing said received reply to the questionnaire using data stored in first and second databases to produce processed reply data, means for having said processed reply data being displayed, and means for updating said second database by storing said processed reply data in said second database.

In the present invention, said questionnaire is stored in said first database, and said means for updating said second database stores, in said second database, processed reply data obtained by processing a reply to a free questionnaire that is a part of said questionnaire stored in said first database, or processed reply data obtained by processing a reply to a charged questionnaire that includes all question items of said questionnaire stored in said first database.

In the present invention, said processing means includes means for changing said reply to said questionnaire to numerical data using the data in said first database, and means for ranking said numerical data using the data stored in said second database to obtain said processed reply data. In the present invention, said first database further stores point data associated said reply to said questionnaire, question items in said questionnaire are sorted into categories of company reliability, and said server further comprises means for selecting and accumulating, for each category of said company reliability, the point data corresponding to replies to said question items. In the present invention, said processed reply data constitute consultation information concerning company reliability.

The present invention further provides a company diagnosis method comprising the steps of having a questionnaire being displayed via a network, receiving a reply to said questionnaire via said network, processing said received reply to the questionnaire using data stored in first and second databases to produce processed reply data, having said processed reply data being displayed, and updating said second database by storing said processed reply data in said second database.

In the present invention, said questionnaire is stored in said first database, and said step of updating said second database includes the step of storing, in said second database, processed reply data obtained by processing a reply to a free questionnaire that is a part of said questionnaire stored in said first database, or processed reply data obtained by processing a reply to a charged questionnaire that includes all question items of said questionnaire stored in said first database.

In the present invention, said processing step includes the steps of changing said reply to said questionnaire to numerical data using the data in said first database, and ranking said numerical data using the data stored in said second database to obtain said processed reply data. In the present invention, said first database further stores point data associated said reply to said questionnaire, question items in said questionnaire are sorted into categories of company reliability, and said method further comprises the step of selecting and accumulating, for each category of said company reliability, the point data corresponding to replies to said question items.

In the present invention, said processed reply data constitute consultation information concerning company reliability.

The present invention further provides a computer-readable recording medium on which a computer-readable program is stored for use in a company diagnosis system for providing company consultation information, said computer-readable program causing a computer to execute a company diagnosis method comprising the steps of having a questionnaire being displayed via a network, receiving a reply to said questionnaire via said network, processing said received reply to the questionnaire using data stored in first and second databases to produce processed reply data, having said processed reply data being displayed, and updating said second database by storing said processed reply data in said second database.

In the present invention, said questionnaire is stored in said first database, and said step of updating said second database includes the step of storing, in said second database, processed reply data obtained by processing a reply to a free questionnaire that is a part of said questionnaire stored in said first database, or processed reply data obtained by processing a reply to a charged questionnaire that includes all question items of said questionnaire stored in said first database.

In the present invention, said processing step includes the steps of changing said reply to said questionnaire to numerical data using the data in said first database, and ranking said numerical data using the data stored in said second database to obtain said processed reply data. In the present invention, said first database further stores point data associated with replies to question items in said questionnaire sorted into categories of company reliability, and said method further comprises the steps of selecting and accumulating, for each category of said company reliability, the point data corresponding to said replies to said question items, and having said processed reply data being displayed as consultation information concerning said company reliability.

### BRIEF DESCRIPTION OF THE DRAWINGS

FIG. 1 is a schematic diagram showing a company diagnosis system according to the present invention.

FIG. 2 is a diagram showing the structure of a database for the company diagnosis server of the present invention in which question items for a questionnaire are stored.

FIG. 3 is a schematic diagram showing categories and check list items used for diagnosing the company reliability.

FIG. 4 is a diagram showing the data structure used to change replies to the question items into numerical data.

FIGS. 5 to 7 are detailed diagrams showing management levels and check list items used in the present invention.

FIG. 8 is a diagram showing the structure of an array for question numbers and numerical data obtained from the replies to the question items.

FIG. 9 is a schematic diagram showing diagnostic data included in a database DB2.

FIG. 10 is a diagram showing company profiles and company profile identifiers associated with the respective company profiles.

FIG. 11 is a diagram showing a charge system used in the present invention.

FIG. 12 is a flowchart showing a server process for the simplified diagnosis according to the present invention.

FIG. 13 is a flowchart showing a deviation value calculation process according to the present invention.

FIG. 14 is a flowchart showing another server process for the company diagnosis server according to the present invention.

FIG. 15 is a flowchart showing a detailed diagnosis process according to the present invention.

FIG. 16 is a diagram showing a second embodiment of the simplified diagnosis process according to the present invention.

FIG. 17 is a diagram showing a second embodiment of the detailed diagnosis process according to the present invention.

FIG. 18 is a diagram showing an exception process according to present the invention.

FIG. 19 is a diagram showing a display screen of a top page provided by the company diagnosis system of the present invention.

FIG. 20 is a diagram showing a display screen for system introduction provided by the company diagnosis system of the present invention.

FIG. 21 is a diagram showing a display screen for diagnosis program selection provided by the company diagnosis system of the present invention.

FIG. 22 is a diagram showing a company profile input screen provided by the company diagnosis system of the present invention.

FIG. 23 is a diagram showing a user ID and password input screen provided by the company diagnosis system of the present invention.

FIG. 24 is a diagram showing exemplary question items provided for the simplified diagnosis in the present invention.

FIG. 25 is a diagram showing the diagnostic results of the simplified diagnosis provided by the company diagnosis system of the present invention.

FIG. 26 is a diagram showing a display screen displaying total evaluation results obtained by the detailed diagnosis according to the present invention.

FIG. 27 is a diagram showing a business process when the company diagnosis system of the present invention is applied to a consultation system.

### DESCRIPTION OF THE PREFERRED EMBODIMENTS

A company diagnosis system for providing consultation information concerning company reliability according to the preferred embodiments of the present invention will now be described. However, the present invention is not limited to these embodiments.

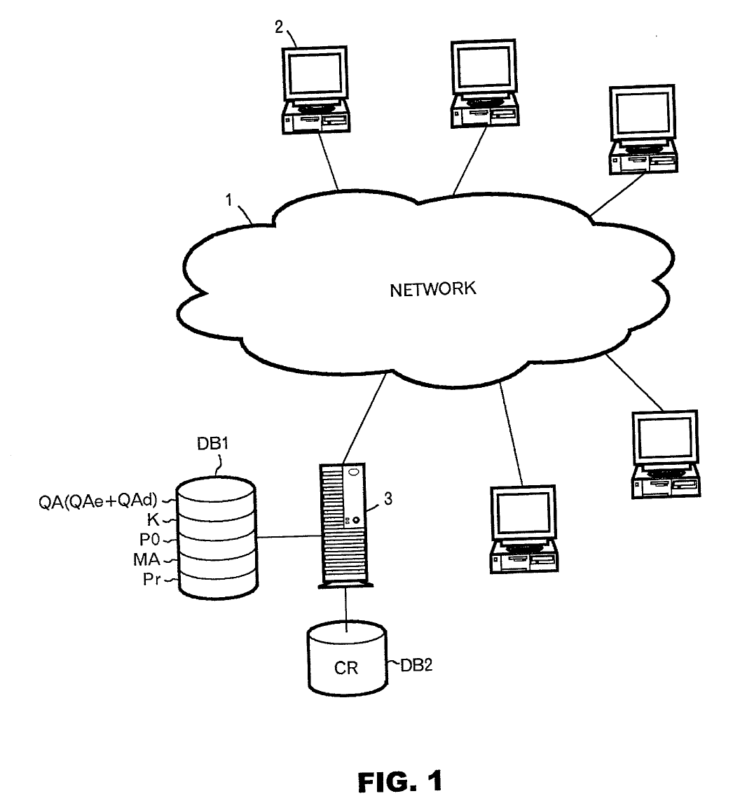

FIG. 1 illustrates an overview of the company diagnosis system according to the invention. The company diagnosis system of the present invention comprises a computer 2 for transmitting a reply to a questionnaire via a network 1, and a company diagnosis server 3 for receiving and processing the reply transmitted from the computer 2.

The network 1 in the embodiment is preferably the Internet, but any other network may also be used so long as information can be remotely exchanged, such as optical communication, LAN or WAN, using an appropriate communication protocol. A typical communication protocol is TCP/IP, but other protocols may also be used.

The computer 2 or the company diagnosis server 3 used for the invention may be constituted by a personal computer or a workstation. The personal computer or the workstation is equipped with a CPU such as Pentium (trademark of Intel Corporation) or a compatible CPU that can run an operating system such as Windows NT (trademark of Microsoft Corporation), OS/2 (trademark of International Business Machines Corporation), AIX (trademark of International Business Machines Corporation), UNIX (trademark of X/Open), or LINUX. Note, however, that the computer 2 and the server 3 are not limited to such a personal computer or workstation.

The company diagnosis server 3 of the present invention includes a database DB1. Stored in the database DB1 are question items QA of a questionnaire, which may be prepared by those who set up the company diagnosis server 3 for performing a company diagnosis such as a consultation, categories K of the question items, point data PO and management levels KA associated with the question items for converting replies to the question items into processed reply data, and company profiles Pr. Data such as the company profiles Pr, which can be fixed irrespective of the users, may be stored in a separate memory such as a ROM. The question items QA included in the database DB1 consists of a first set of question items Qae for simplified diagnosis which is free, and a second set of question items Qad for detailed diagnosis which is charged.

The company diagnosis server 3 used in the company diagnosis system of the present invention shown in FIG. 1 also includes a database DB2. The database DB2 accumulates, as diagnosis data CR, the processed reply data obtained from previous consultations. The accumulated diagnosis data CR are used as a population in a statistical method to provide, as objective numerical data, consultation information relating to company reliability of a user who has requested the consultation information. Before a company diagnosis is started, replies to the question items may be collected with cooperation from concerned or arbitrarily selected companies, and stored as exemplary initial diagnosis data.

In the present invention, the processed reply data may be obtained by evaluating, between a perfect score and zero, numerical reply data obtained from the simplified and detailed diagnoses, and ranking the evaluated results to obtain absolute evaluation data. Alternatively, in the present invention, the processed reply data may be obtained as relative evaluation data by statistically processing the numerical reply data to generate ranked deviation values. Furthermore, the processed reply data which are obtained as the absolute and relative evaluation data may be stored as diagnostic data in separate storage areas in the database DB 2.

The database DB2 in the company diagnosis system shown in FIG. 1 may include storage areas for separately storing, as diagnostic data CR, the processed reply data obtained from the simplified and detailed diagnoses, respectively. When a set of question items used for the simplified diagnosis is so selected that, on the whole, the reliability is balanced relative to a set of question items used for the detailed diagnosis and that it has little affect on the results of population obtained by the detailed diagnosis, the processed reply data obtained from the simplified diagnosis may be added to the processed reply data obtained from the detailed diagnosis to generate a single set of diagnostic data CR. While, in FIG. 1, the above described databases DB1 and DB2 are shown as separate databases, they need only be functionally distinguished from each other. In the present invention, the databases DB1 and DB2 may be constituted by either a single set or plural sets of database software and hardware depending on individual functions.

As described above, the company diagnosis system of the present invention which uses the company diagnosis server 3 can improve the accuracy of diagnostic information from the consultations by drawing user's interest to the company diagnosis system through the simplified diagnosis or free consultation service, and refining the data in the database DB2 which accumulates previous diagnostic data.

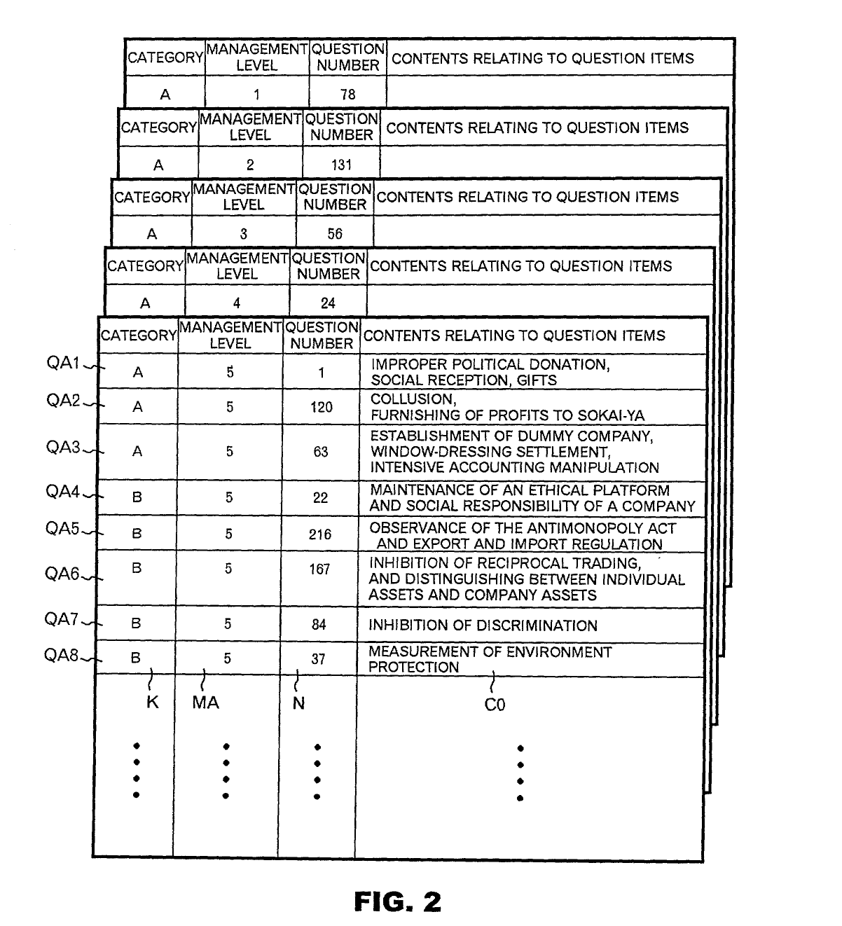

FIG. 2 illustrates an exemplary format of question items stored in the database DB1. As shown in FIG. 2, the database DB1 of the company diagnosis system contains, for example, question items QA1-QA8 each of which is classified into a specific category K relating to company's soundness and credibility, such as company administration A or fundamental matter B relating to the conduct of business. Other categories K in the present invention include soundness C of the business aspect, diagnosis D concerning all aspects, diagnosis E concerning plural aspects, and diagnosis F concerning a single aspect.

Furthermore, a selected one of management levels MA5-MA1 is given to each of the question items QA. The management levels MA relate to the degree of importance for the company's soundness and credibility of the question items QA. For example, the management level MA5 represents the most important question items for the soundness and credibility while the management level MA1 is given to the question items which are preferably to be obeyed but would not greatly affect the soundness and credibility even if they are not obeyed. FIG. 2 shows that the question items constitute a data class for each management level MA.

A unique question number N is assigned to each question items QA. The question number N is assigned at random so that a user can not identify a category K and a management level MA from the question number N. FIG. 2 also shows the content CO of each question item relating to the company reliability. For example, a question item with a question number N=1 may be “Has your company contributed political funds to a specific political organization for a purpose other than the support of that organization?” which relates to the company administration in the category K=A. While the question items constitute a data class for each management level MA in FIG. 2, the data class may be constituted for each category K in the present invention.

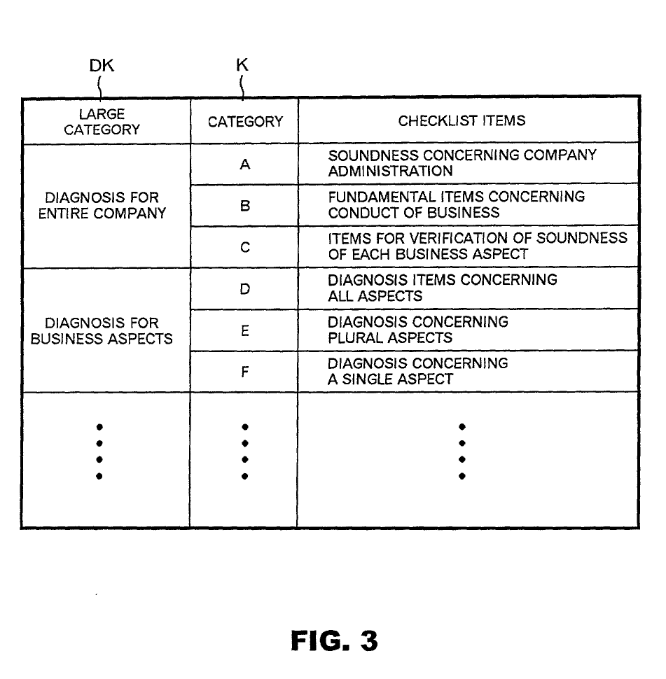

FIG. 3 illustrates a table including the categories K for the question items QA, and check list items for the company reliability which are examined in the respective categories K. This check list may be stored in the database DB1. Fixed data which do not depend on user's inputs may be stored in a ROM. As shown in FIG. 3, the categories K are classified into larger categories DK representing diagnoses for the entire company and for the business aspect, respectively. In FIG. 3, for example, category=A includes a check list item for the soundness related to the company administration, and category=B includes a check list item for the fundamental item related to the conduct of business. The question items QA presented to a user are prepared to reflect the check list items of the respective categories K. In the present invention, a detailed diagnosis that will be described later may be performed either for each larger category DK or for each category K. The above described categories K are presented for an illustration purpose only, and any category required for a diagnosis may be used and one or more categories may be added or deleted as the case may be.

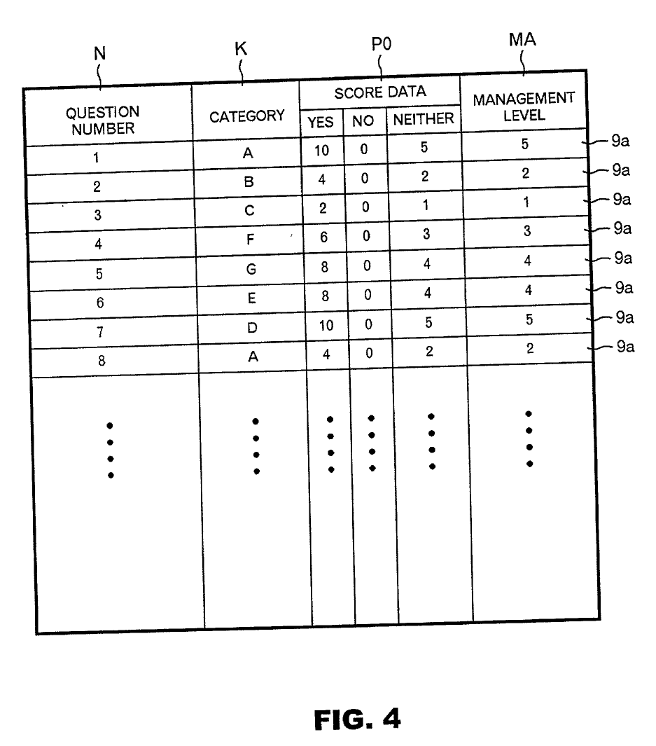

FIG. 4 illustrates a data structure used to change, into numerical data, replies to the question items QA stored in the database 1 of the company diagnosis server 3. A first column or field contains question numbers N assigned to the question items QA, starting from one and ending at a number corresponding to the number of question items. A second field contains categories K of the respective question items QA. In the data structure shown in FIG. 4, point data to be assigned to the replies to the question items QA received from a user to change the replies into numerical data are contained in a third field. In the embodiment shown in FIG. 4, for example, when a user replies with “yes” to the question number 1 in the questionnaire, ten points are given as the score for the question. Each score or point in the point data may be assigned an appropriate numerical value in such a manner that the company diagnosis system having the company diagnosis server 3 provides a value of, for example, 100 for each category K when the system totalizes the points of reply data representing the highest company reliability. However, in the present invention, different values or criteria may be used so long as appropriate ranking can be performed.

In the embodiment shown in FIG. 4, the management level MA assigned to each question item QA is related to the point of that question item QA. For example, in FIG. 4, the points for the “yes” replies to the question items QA having higher management levels MA are set to higher values while the points of the “yes” replies to the question items QA having lower management levels MA are set to lower values. Note that the point data structure shown in FIG. 4 is merely an example, and the present invention may use a different structure in which, for example, the “yes” “no” and “neither” replies to the question items QA are always assigned “10”, “0”, and an intermediate value, respectively, irrespective of the management level MA. Alternatively, the management levels MA may be used as weighting factors when the reply points are totalized. In the embodiment shown in FIG. 4, the management levels MA are used as linear weighting factors. So long as appropriate points can be obtained from the reply data for the questionnaire, the weighting factors may be linear, quadratic, cubic, exponential, or any combination thereof.

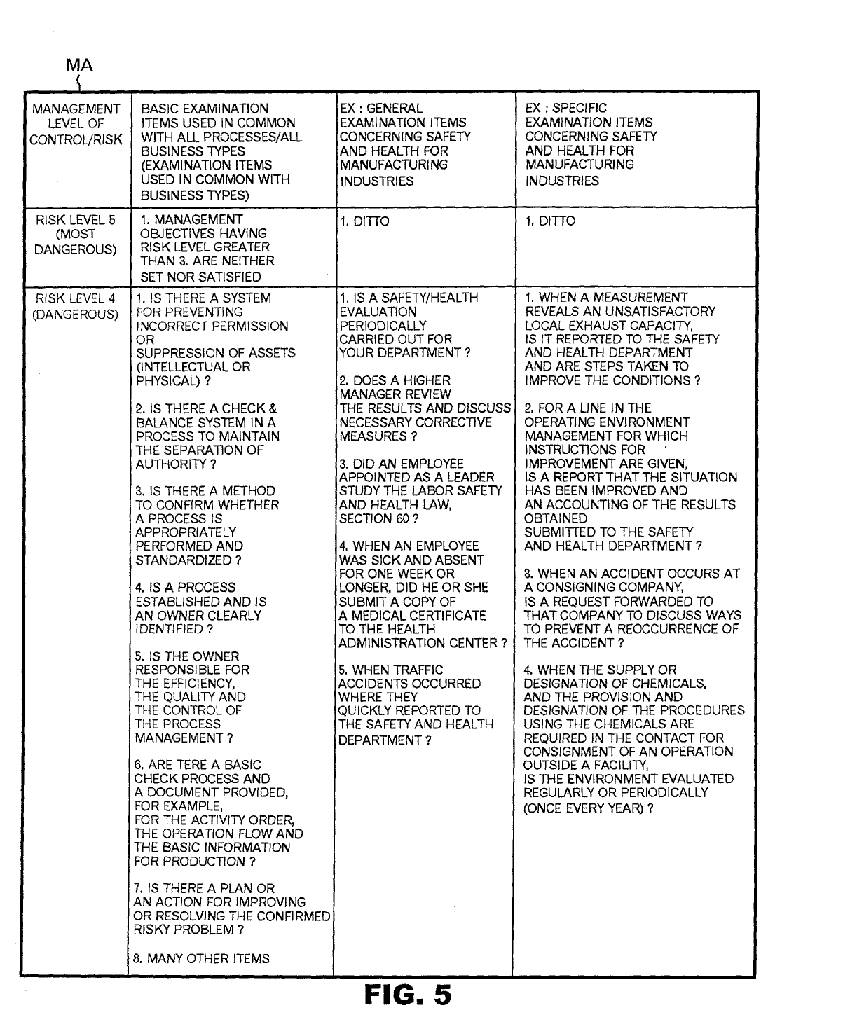

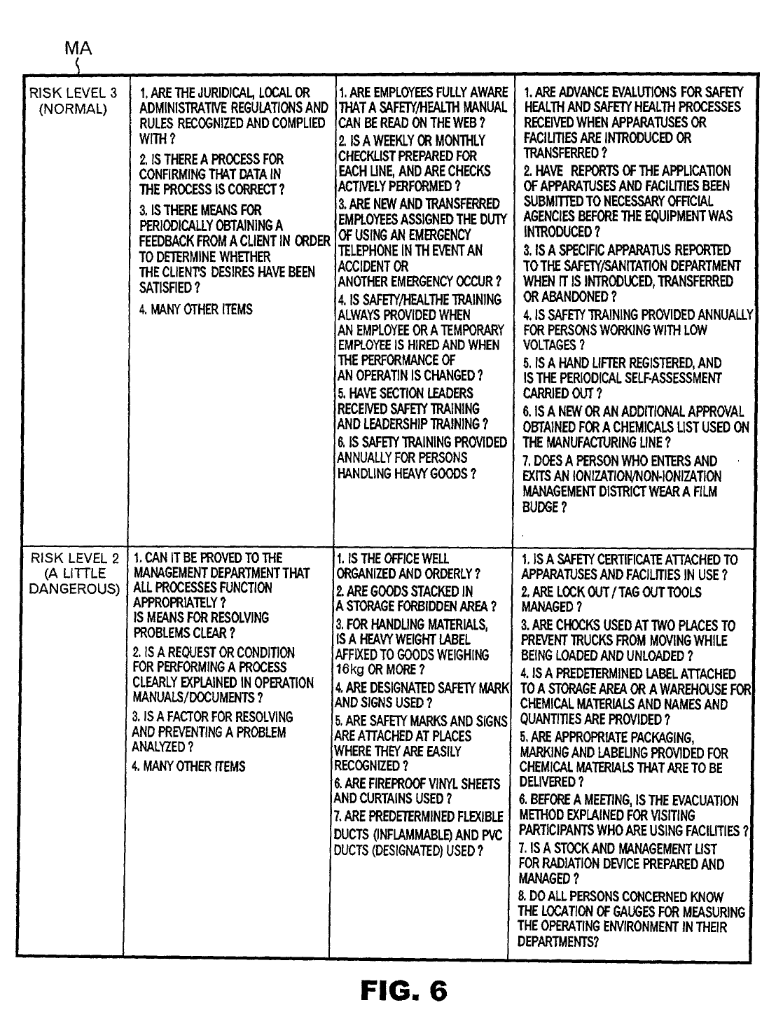

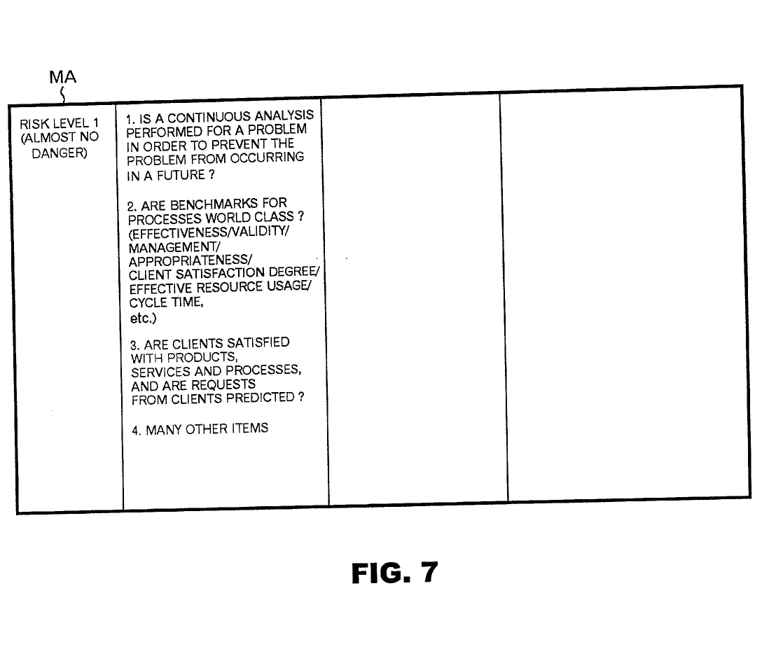

FIGS. 5 to 7 illustrates exemplary management levels MA used in the present invention and their contents. While the management levels MA shown in FIGS. 5 to 7 represent risk levels, classification and types of the management levels MA are shown for an illustration purpose only, and any management level may be used in the present invention as the case may be.

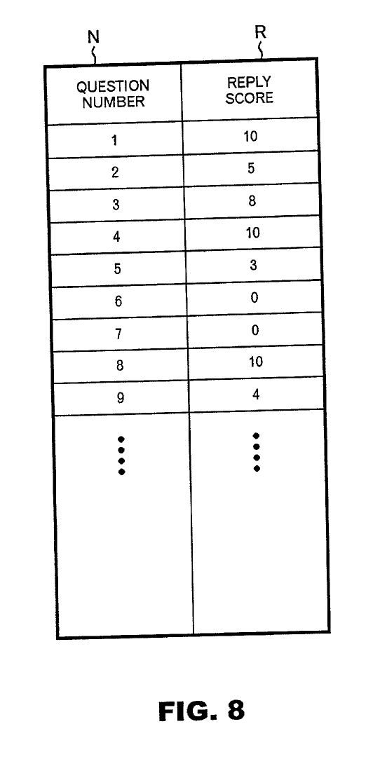

A process for changing the replies to the question items into the numerical data is described. In the present invention, a reply to a question item QA received by the company diagnosis server 3 may include a pair (N,R) of a question number N assigned to that question item QA and a reply R thereto. When the company diagnosis server 3 receives a reply to a question item, the server 3 reads its question number N and reply R, and changes the reply into numerical data by referencing the point data shown in FIG. 4 to retrieve a point corresponding to the reply R. FIG. 8 illustrates a data arrangement structure consisting of question numbers N assigned to the question items and numerical data corresponding to the respective question numbers N. This data arrangement structure may be stored in a buffer memory or a separate database for storing the reply data, until a necessary process is performed.

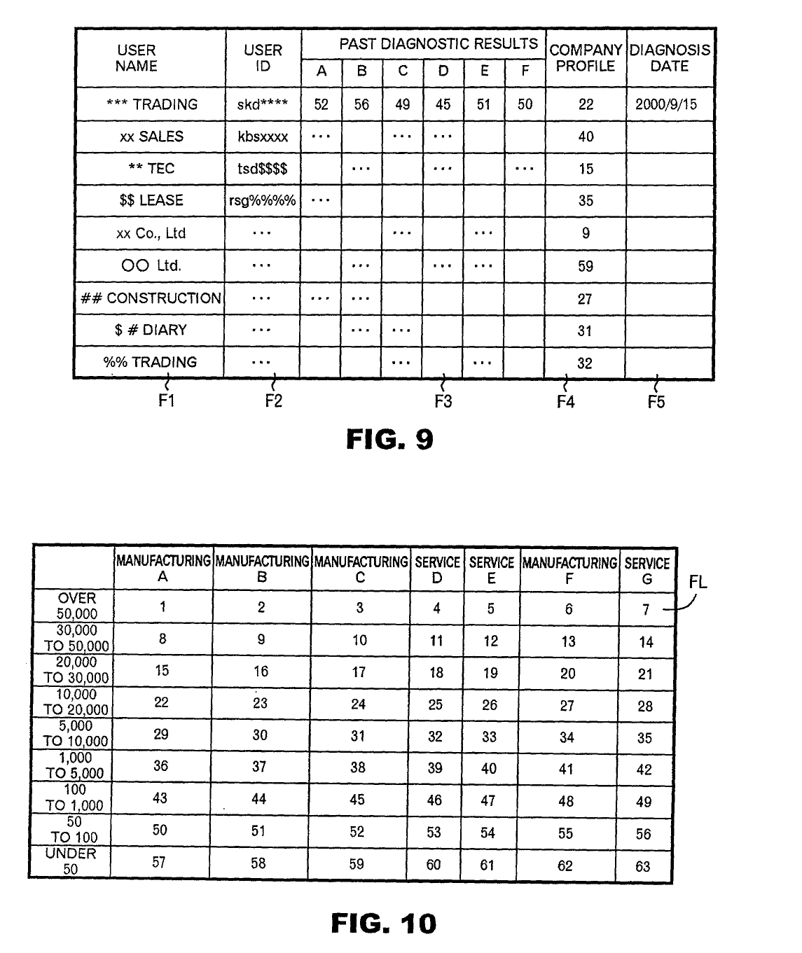

FIG. 9 illustrates a data structure for diagnostic data of companies which were diagnosed in the past. The data structure is stored in the database DB2 of the company diagnosis server 3. In the embodiment shown in FIG. 9, the diagnostic data comprise plural fields F1 to F4 which contain user names, user IDs, numerical data representing diagnosis results obtained in the past diagnoses, and company profile identifiers FL corresponding to the respective company profiles Pr of users diagnosed in the past, respectively. The numerals shown in the field of the company profiles are used as company profile identifiers for calculating a deviation value for each company profile Pr, which will be described later.

The data structure shown in FIG. 9 further comprises a field F5 which contains, as time stamps, dates when diagnoses were conducted so that diagnostic data can be identified even if the same company shown in FIG. 9 was diagnosed several times in different ways. By using such a data structure in the database DB2, a user ID can be used to identify a company name, and corresponding diagnosis results, company profile and date of diagnosis. While results of the detailed and simplified diagnoses are not separately shown in the data structure of FIG. 9, they may be distinguished from each other by including identifiers, such as company profile identifiers, in the data structure to perform a statistical process for each diagnosis type.

FIG. 10 illustrates an exemplary classification of the company profiles Pr described with reference to FIG. 9. In the present invention, a company profile Pr includes the number of employees and type of business of a company. Companies to be diagnosed are classified into 63 classes in accordance with the number of employees and type of business, and each class is allotted a unique number used as a company profile identifier FL. In the embodiment shown in FIG. 10, for example, a company profile identifier FL=1 is allotted to a company profile Pr for a manufacturing industry A with more than 50,000 employees, and a company profile identifier FL=63 is allotted to a service business G with 50 or less employees.

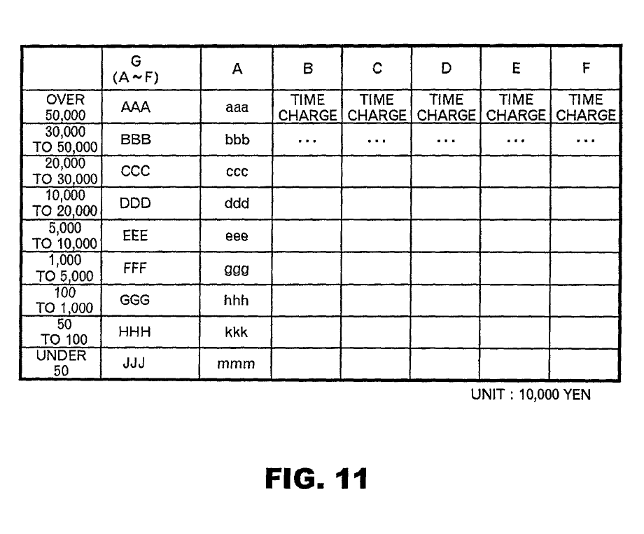

FIG. 11 illustrates a charge system for the company diagnosis system of the present invention. The charge system shown in FIG. 11 is established in accordance with company scale, as represented by the number of company employees, and the categories to be diagnosed. Since the charges are determined based on the company scale, availability of the company diagnosis system of the present invention would be improved. The charge system may be displayed on a web page which explains an outline of the company diagnosis system of the present invention, or may be displayed on a web page during a sequence of processes described later so that the charge information is provided for a user before the diagnosis is initiated.

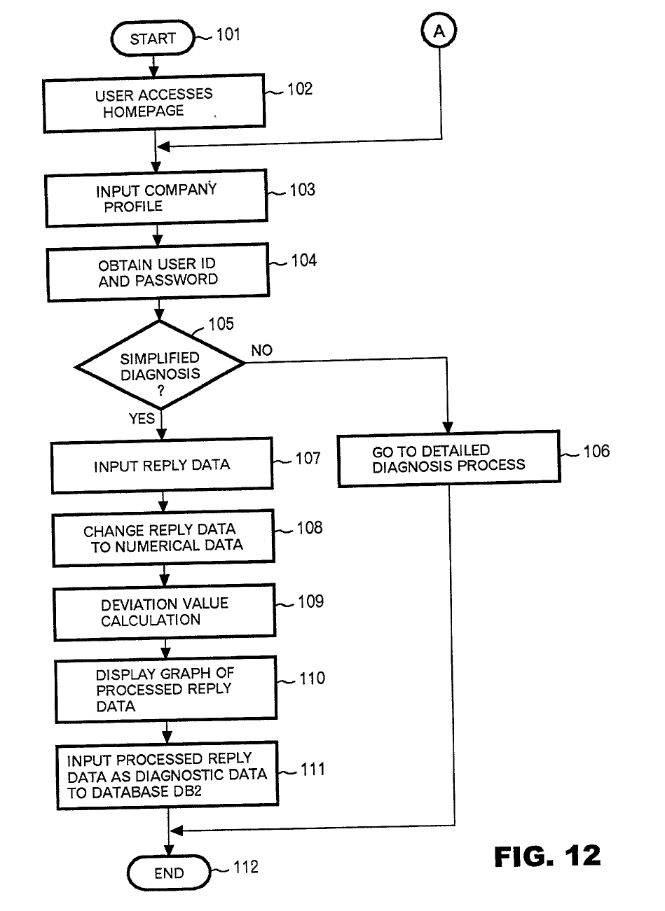

FIG. 12 is a flowchart showing a typical operation performed by the company diagnosis server 3 for the company diagnosis system of the present invention. In FIG. 12, it is assumed that a user does not yet have authentication information such as a user ID, and that the user accesses to the system for the first time. The server process according to the present invention is initiated at step 101, and the user accesses the web page via the network 1 at step 102. Then, at step 103, the user inputs a company profile on a screen which is displayed on the web page for that purpose. At step 104, the user obtains a user ID for free. At that time, the user may be requested to input account information such as a credit card number or a bank account number, which is required to consult in the charged, detailed diagnosis which will be described later.

At step 105, the company diagnosis server 3 prompts the user to select either the free, simplified diagnosis to ascertain the level of consultation to be provided by the company diagnosis system of the present invention, or the charged, detailed diagnosis. If the user selects the detailed diagnosis (no), the server process branches to step 106 to perform the detailed diagnosis process. This detailed diagnosis process will be described in more detail later.

If, at step 105, the user selects the simplified diagnosis (yes), the server process goes to step 107 to display, on the screen of the computer 2 installed at the user site, a web page containing a set of question items for the simplified diagnosis, and to permit the user to enter reply data for the question items QA. The question items used for the simplified diagnosis may be selected from the question items for the detailed diagnosis in advance by taking balance in each of the categories K into consideration, and stored in the database DB1 as a smaller set of question items.

Alternatively, in the present invention, plural sets of question items for the simplified diagnosis may be prepared in advance, and a randomly selected one of the sets may be displayed to the user when the user accesses the web page.

When the same user accesses the web page to repeat the simplified diagnosis for which the plural sets of question items have been prepared, the simplified diagnosis history may be examined to present a different set of question items from the one used in the past diagnosis. Therefore, the same user would try the free, simplified diagnosis several times with a sense of play. By utilizing such repeated accesses by the user with a sense of play, the diagnostic data stored in the database DB2 of the company diagnosis server 3 may be progressively improved so that more reliable company diagnoses may be implemented.

The server process then proceeds to step 108 where the company diagnosis server 3, which has received the replies to the simplified diagnosis question items, uses the data explained with reference to FIGS. 4 and 8 to change the replies to numerical data. Then, at step 109, deviation values are calculated from the user's replies to the question items by using the past diagnostic data stored in the database DB2. The deviation value calculation at step 109 will be described in more detail later.

The server process then proceeds to step 110 to present to the user the processed reply data for each category K as diagnostic results which are displayed on the web page in the form of graph, table, etc. so that the user can readily understand the results visually. In the present invention, absolute scales may be used to present the results of the simplified diagnosis as absolute evaluation data to the user. When the absolute evaluation data are presented to the user, a point range between the highest possible score for the simplified diagnosis and zero is divided into several ranks, e.g., ranks 1 to 5, beginning with the score representative of the highest company reliability, and the processed reply data are obtained by determining which rank the scores or totalized numerical data corresponding to the user's replies to the question items for the simplified diagnosis belong. The processed reply data are then presented to the user as diagnostic results in the form of graph, table or the like. The reply data used in the above may be summed reply data for calculating the deviation values in the deviation value calculation step which will be described later.

In the present invention, when the points or scores are ranked in the absolute evaluation, the range between the highest possible score and zero may be divided into equal intervals. Note, however, that any other statistical or empirical method may also be used to divide the point range into plural intervals so long as it is statistically appropriate. For example, since it is expected that both perfect and zero scores are rare in the company diagnosis results, ranks 1 and 5 may be made narrower while ranks 2 to 4 may be made wider. Alternatively, if appropriate, relative evaluation based on the above deviation values may be used to present the diagnostic results of the simplified diagnosis to the user.

Then, at step 111, the processed reply data and additional information such as the user ID are written in the database DB2 to update the database DB2. At that time, the diagnostic data of the simplified diagnosis may be stored separately from the diagnostic data of the detailed diagnosis in the database DB2, as described with reference to FIG. 1, or both diagnostic data may be mixedly stored without distinguishing from each other.

When the absolute evaluation is used to obtain the reply data for the invention, the results of the simplified and detailed diagnoses are stored in the database DB2 without affecting the reliability of the detailed diagnosis after the scores of the reply data obtained from the simplified diagnosis are normalized by the highest possible score for the simplified diagnosis question items, and the scores in the absolute evaluation obtained from the detailed diagnosis are normalized by the highest possible score for the detailed diagnosis question items, so that the reliability of the diagnoses is improved. When the relative evaluation is used, the scores of the reply data are changed to deviation values, which may then be stored in the database DB2 as they are if the simplified diagnosis question items constitute an appropriate subset of the detailed diagnosis question items.

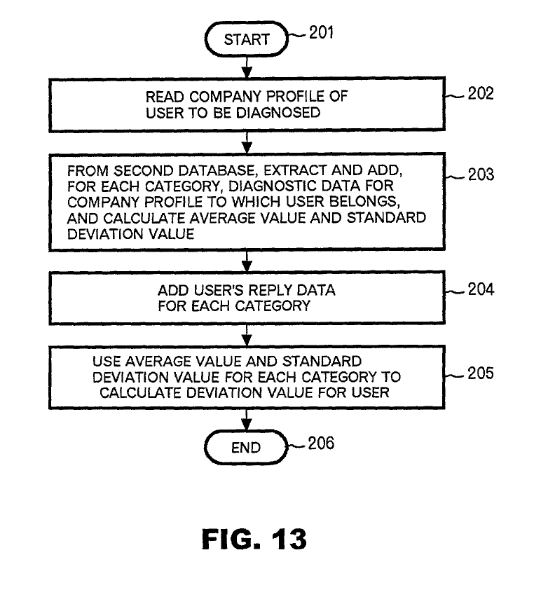

FIG. 13 is a flowchart for the deviation value calculation process performed at step 109 in the server process of the present invention. The deviation value calculation process is initiated at step 201, and the company profile identifier FL corresponding to the company profile Pr of the user to be diagnosed is read at step 202. Then, at step 203, the reply data for the question items indicated by the company profile identifier FL corresponding to the company profile Pr to which the user belongs, are read from the database DB2 for each category K and are added together. The processed reply data obtained by the absolute evaluation in which the numerical reply data are added together and the resulting values are ranked, are the diagnostic results to be presented to the user in the simplified diagnosis, or may be used to present the absolute evaluation to the user in the detailed diagnosis. The average and standard deviation of the past diagnostic data are also calculated. At step 204, the user's reply data for the question items are added together for each category K to obtain a score of each category. Since it cannot be determined at this time whether the user to be newly diagnosed has transmitted arbitrary data, especially in the simplified diagnosis, as will be described later, the average value and standard deviation are calculated without using the reply data from the new user.

Then, at step 205, a deviation value of the user to be newly diagnosed is calculated for each category K, using the average value and the standard deviation, which constitutes the processed reply data to be presented to the user. Any known method may be used for the calculation of the deviation values, e.g., a deviation value of 50 is given to the average value, and differences from the average are normalized by the standard deviation and added.

The deviation value calculation process described above may be used for both the simplified diagnosis and the detailed diagnosis because only the question items used therein differ.

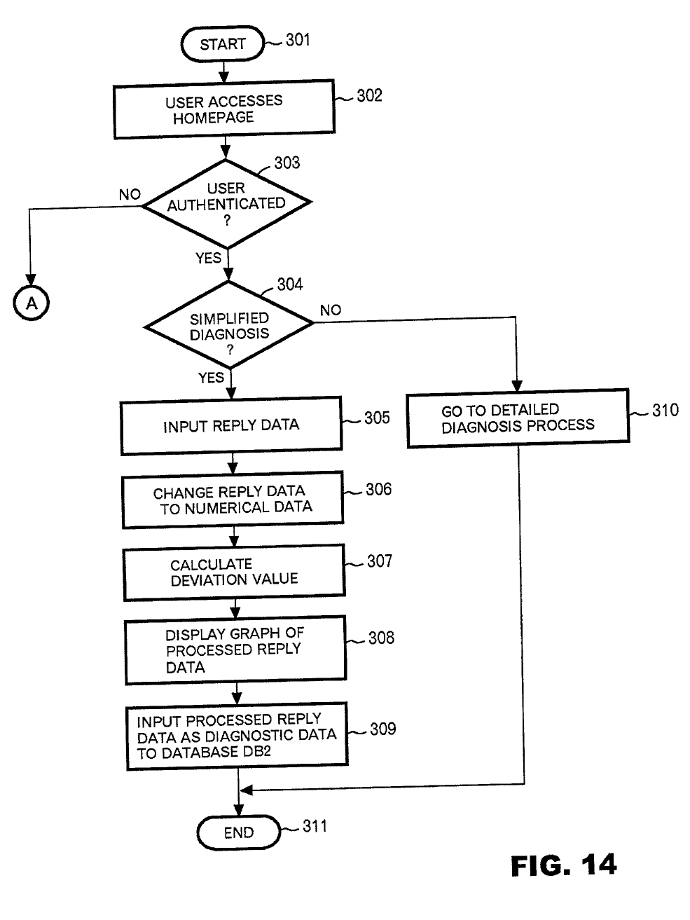

FIG. 14 is a flowchart showing the server process performed in this embodiment when a user who has experienced the simplified diagnosis or the detailed diagnosis in the company diagnosis system of the present invention again accesses the home page. The server process in FIG. 14 is initiated at step 301, and the user accesses the home page at step 302. The company diagnosis server 3 accessed by the user authenticates the user ID and the password entered by the user. If the user ID and the password are authenticated (yes), the user is requested to select either the simplified diagnosis or the detailed diagnosis at step 304. At this time, the user is not requested to input the company profile. If the user ID and the password are not authenticated, the server process branches to step 103 in FIG. 12 to register the company profile, user ID and password.

If, at step 304, the user who has previously been registered desires the simplified diagnosis for another category (yes), the simplified diagnosis at steps 305 to 309 is executed for free. This process can be performed in the same manner as explained with reference to FIG. 12. On the other hand, if, at step 304, the user desires the detailed diagnosis rather than the simplified diagnosis (no), the detailed diagnosis process is initiated at step 310. In this case, the charge system for the detailed diagnosis may be displayed to remind the user that payment for the diagnosis will be required.

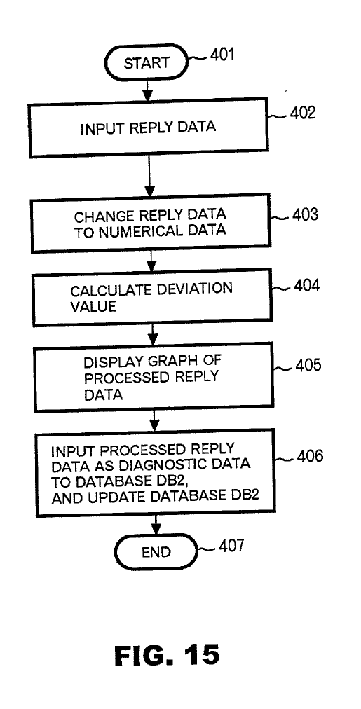

FIG. 15 is a flowchart showing the server process for performing the detailed diagnosis at step 310 in FIG. 14. The server process shown in FIG. 15 is initiated at step 401, and requests the user to input reply data by displaying a set of question items for the detailed diagnosis on the web page at step 402. At step 403, the company diagnosis server 3 receives the reply data for the questionnaire QA, and uses the process explained in detail with reference to FIG. 12 to change the reply data to numerical data. At step 404, the deviation values for the user are calculated using the numerical data obtained at step 403, as explained with reference to FIG. 13, which are used as processed reply data.

At step 405, the processed reply data obtained by adding the numerical reply data in the absolute evaluation, the processed reply data obtained by the statistical processing to calculate the deviation values in the relative evaluation, or both the absolute and relative evaluations are displayed as the diagnostic results on the web page using a graph, table, simulation or a combination thereof. For the absolute evaluation, the range between the highest possible score and the lowest score may be divided into ranks 1 to 5 for each category K of the detailed diagnosis question items, as explained above for the simplified diagnosis. At step 406, the processed reply data are stored in the database DB2 to update the diagnostic data therein so that the reliability of the database DB2 is improved. Then, at step 407, the server process for the detailed diagnosis is terminated.

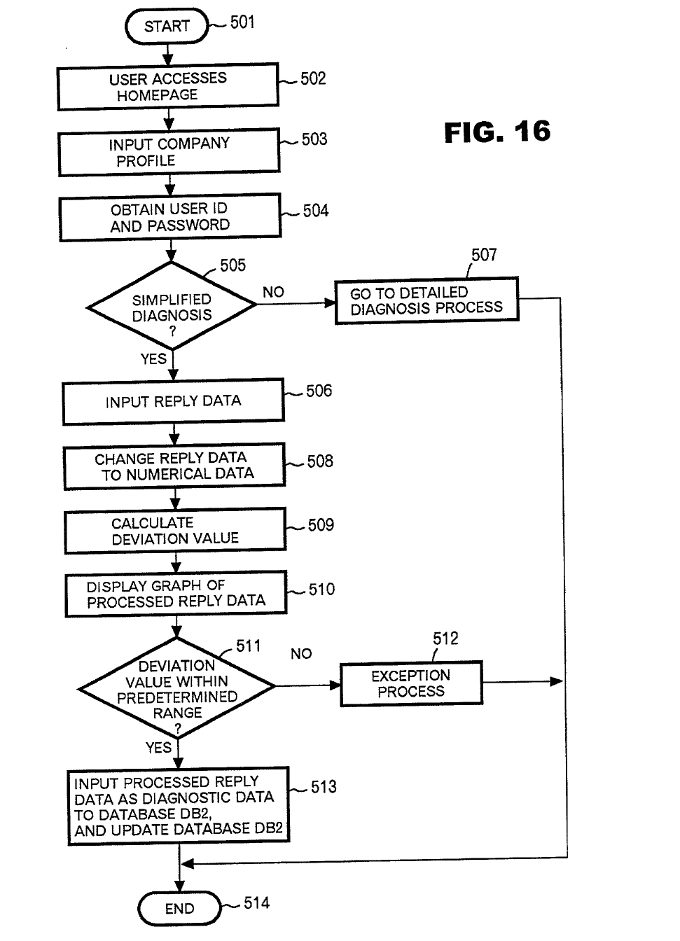

FIG. 16 illustrates a second embodiment of the company diagnosis method according to the present invention. In this embodiment, a data evaluation step 511 and an exception process step 512 are added before the processed reply data are stored in the database DB2. The data evaluation step 511 determines whether the reply to the questionnaire was prepared arbitrarily. Since the server process in the company diagnosis method of the present invention shown in FIG. 16 is the same as the one shown in FIGS. 14 and 15, except for the data evaluation step 511 and the exception process step 512, only these two steps will be explained in detail.

The data evaluation step 511 determines whether the deviation value obtained for the user falls within a predetermined range having lower and upper limits of, for example, 35 and 75, respectively. This range is merely an example, and any other limit value may be used as long as it is appropriate for the present invention. If the deviation value obtained for the user is outside the predetermined range (no), the server process branches to step 512 and the exception process is performed. In the present invention, the rank in the absolute evaluation may also be used as a criterion for determining whether the exception process should be performed.

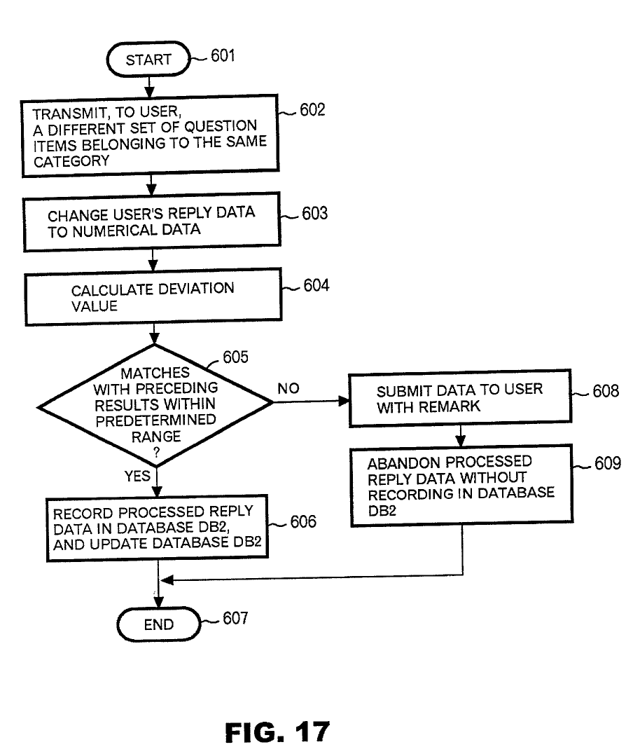

FIG. 17 is a flowchart showing the exception process used in the present invention. This exception process is initiated at step 601. At step 602, a different set of question items corresponding to the same category K, which has produced a deviation value outside the predetermined range, is displayed on the web page to request a new reply by the user. If doubt exist with regard to all the categories, new replies may be requested for all the categories. In that case, different sets of question items may be prepared by extracting at random the question items from those which have previously been replied by the user. Alternatively, predetermined sets of different question items may be separately prepared which are expected to elicit replies corresponding to those which are obtained from normal question items for the same categories.

At step 603, new reply data received from the user are changed to numerical data, as explained with reference to FIGS. 12 and 13, and a deviation value is calculated again at step 604. At step 605, the calculated deviation value is compared with the one previously calculated, and it is determined whether these values match within a predetermined range, e.g., within a range of 10% to 20%. If the results match (yes), the system can confirm that the user's reply actually shifts from the average for the category concerned. Therefore, at step 606, the data are stored in the second database DB2, and at step 607, the server process is terminated. Note that the above criterion used in the exception processing, i.e., 10% to 20%, is merely an example. In the present invention, it may be statistically determined how the reply data are varied in normal cases in which there is no specific intention, by repeatedly administer the questionnaire, and the above criterion may be determined therefrom.

If a difference between the two deviation values exceeds the predetermined range, reliability of the reply data for the question items is doubtful, and, therefore, diagnostic data are reported to the user at step 608 by displaying the data on the web page with comments being attached thereto. However, since the data is less reliable, the data are discarded at step 609 without being recorded in the second database DB2, and the server process is terminated at step 607.

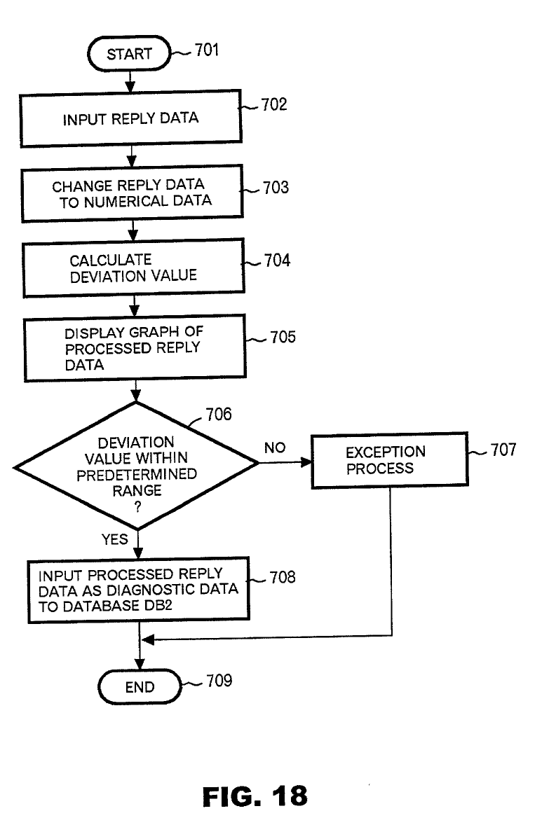

FIG. 18 is a flowchart showing a second embodiment of the detailed diagnosis process in the present server process. In the detailed diagnosis process shown in FIG. 18, a data evaluation process at step 706 and an exception process step at step 707 are additionally provided, as in FIG. 16, so that the reliability of the database DB2 is increased as the diagnostic data are accumulated.

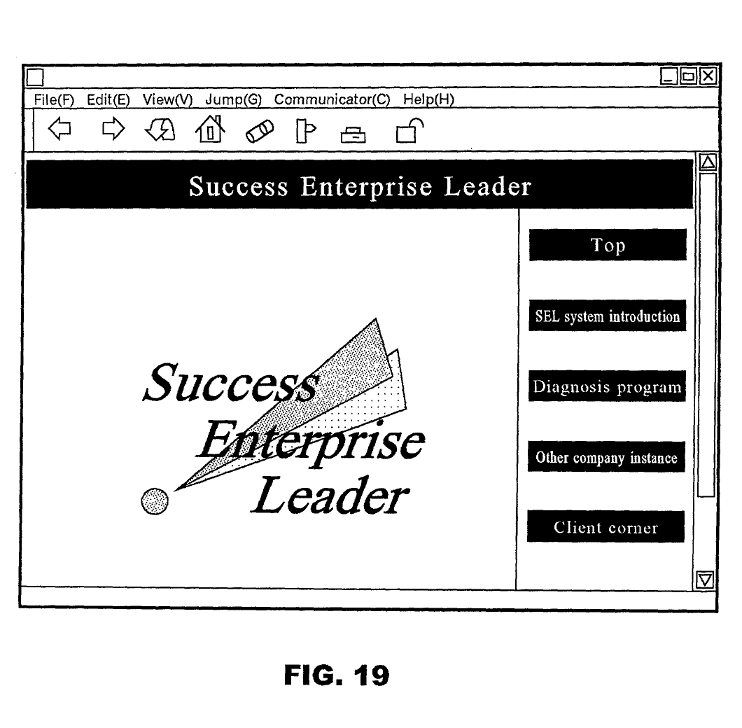

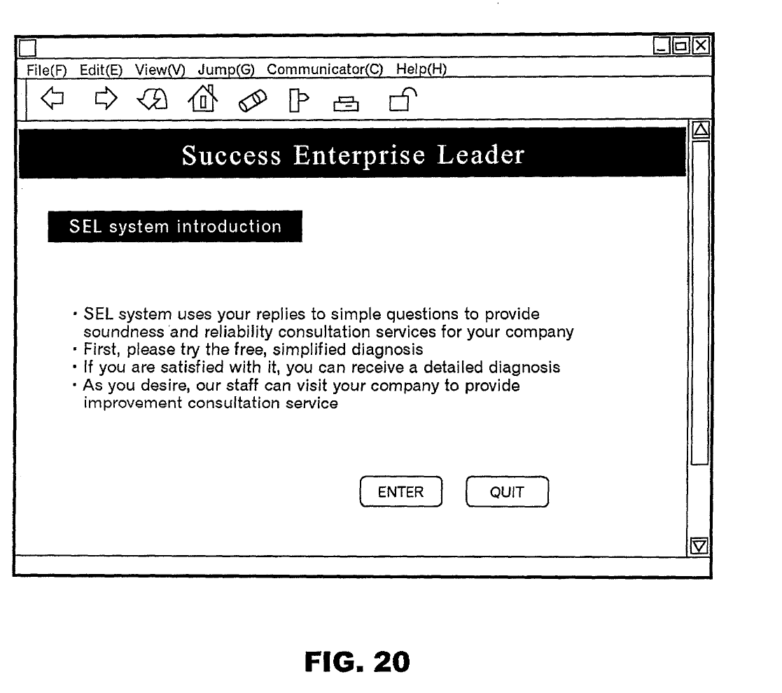

FIG. 19 illustrates a display screen presented, through a web page of a system for providing company consultation information, to the computer 2 of a user who has accessed a home page for the company diagnosis system of the present invention. In FIG. 19, the consultation system in this embodiment, called Success Enterprise Leader, displays a top page “Success Enterprise Leader (SEL)” when a user accesses the home page. On the top page, provided are a “SEL system introduction” button for introducing the SEL system to the user, a “diagnosis program” button for displaying diagnosis screens, an “instances of other companies” button for introducing instances of other companies, and a “client corner” button for accepting various questions or inquiries and request for visiting consultation from the user, so as to promote utilization of the present consultation system by the user. For example, when the user clicks on the “SEL system introduction” button in FIG. 19 by using a pointing device such as a mouse connected to the computer 2, a screen shown in FIG. 20 is displayed.

Guidance for introducing the SEL system is displayed on the screen in FIG. 20, and what kind of value-added information is to be provided by the consultation system is explained. Further displayed on the screen are that the user can try a free simplified diagnosis, that the user can proceed to a detailed diagnosis if satisfied with the simplified diagnosis, and that individual consultation with a staff is available if desired. If the user who accessed the home page desires that the diagnosis be performed, the user clicks the “ENTER” button on the screen. Otherwise, the user may click the “QUIT” button to exit from the home page.

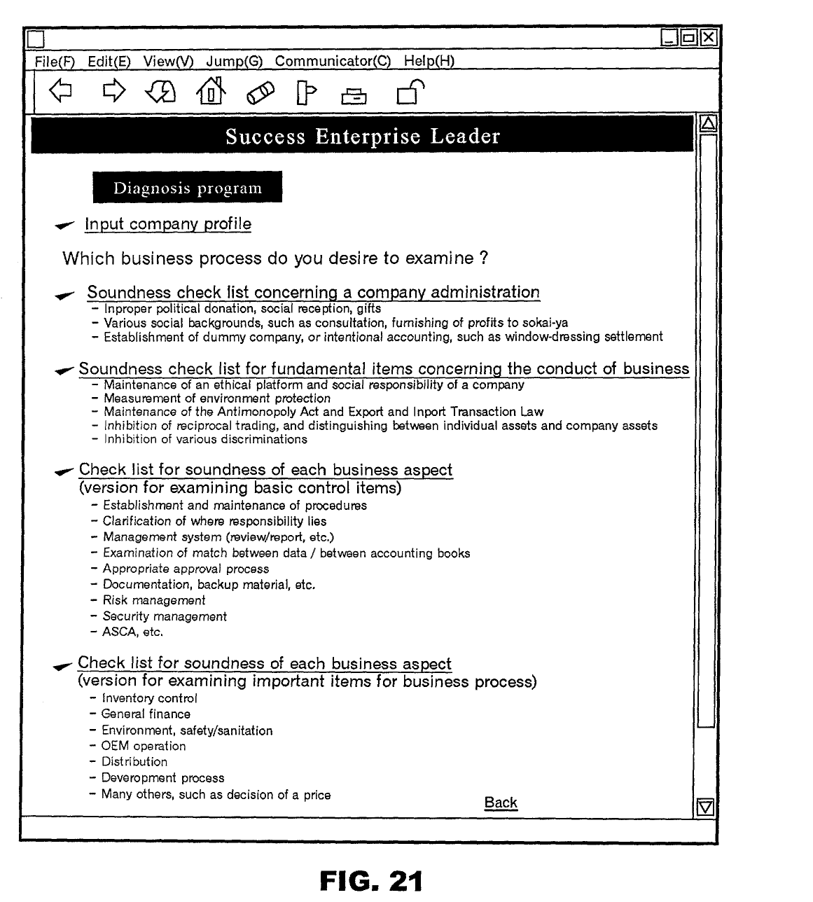

FIG. 21 illustrates a screen of the web page on which a diagnosis program menu is displayed when the user clicks the “ENTER” button in FIG. 20. On the screen shown in FIG. 21, a “company profile input” menu is displayed to have the user input a company profile when the user accesses the consultation system for the first time, so that appropriate consultation can be provided for such a user.

For a user who already has a registered user ID and password, menus are displayed for individual categories, e.g., “soundness check list concerning company administration”, “soundness check concerning conduct of business”, “check list for examining soundness of each business aspect (version for examining fundamental control items)”, and “check list for examining soundness of each business aspect (version for examining important items in each operating process)”. When one of the menus is selected, a screen for a corresponding diagnosis is displayed on the web page.

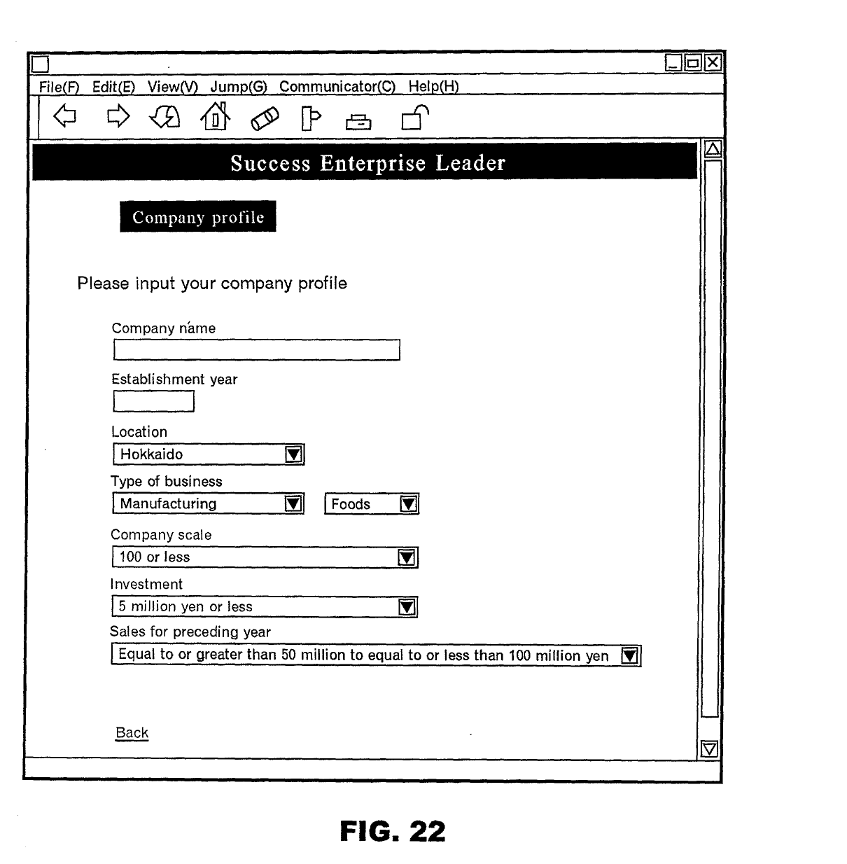

FIG. 22 illustrates a company profile input screen which is displayed when the “company profile input” menu is selected by a user who accessed the consultation system of the present invention for the first time. In the consultation system, it is required to provide information by appropriately judging the reliability and soundness of the company depending on the company scale in order to present accurate value-added information to the user. To this end, before the consultation, the user is requested to input a profile of the user's company so that a company profile identifier FL of a corresponding company profile Pr shown in FIG. 10 can be specified from the input business type and company scale, for use in the succeeding data processing.

In FIG. 22, additional input fields are provided and the user is requested to input information such as name and location of the company which are required to identify and authenticate the company. Further, in FIG. 22, an establishment year input field, an investment input field and a preceding year sales input field are provided to obtain an overview of the company, and to eliminate wasteful effort, such as when a consultant repeatedly inquires the user about information needed for the consultation.

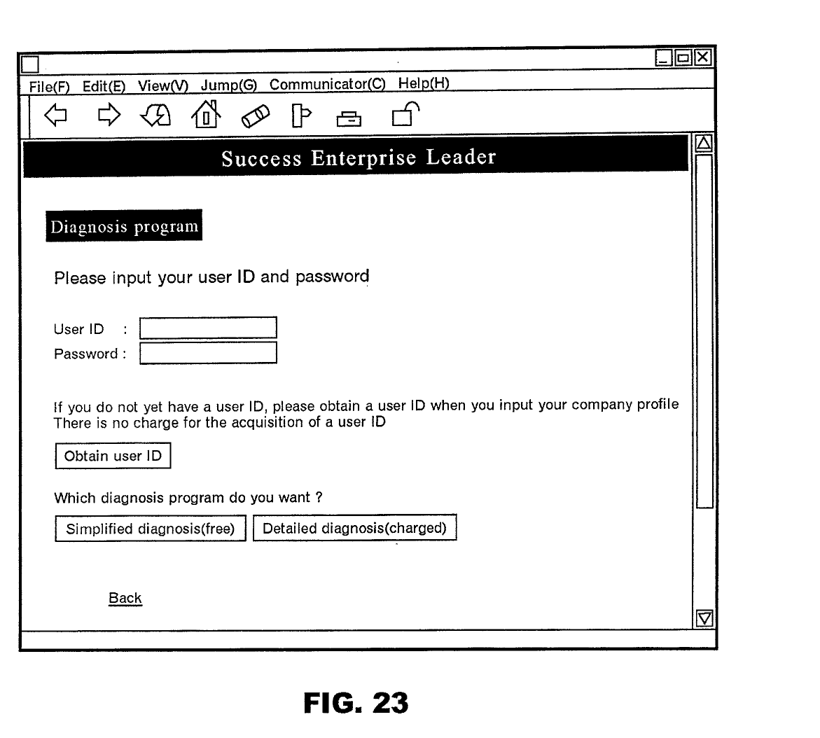

FIG. 23 illustrates a screen displayed on the web page for user authentication when a diagnosis menu is selected by the user who desires to consult the system for a predetermined category shown in the diagnosis program menu in FIG. 21. On the display screen shown in FIG. 23, a user ID input field and a password input field are provided for authentication of the user by the user ID and the password. Further, a user ID acquisition button is provided on the display screen shown in FIG. 23 to allow a user, who has accessed the home page for the first time but has not yet obtained a user ID, to obtain a user ID and a password even when the user clicks the diagnosis menu before obtaining the user ID, so that a company profile Pr of the user can be obtained. When the user ID acquisition button is clicked, the process branches to step 103 in FIG. 12 to initiate the company diagnosis process of the present invention, starting from the acquisition of the company profile Pr.

When the user has already input the company profile, the user then inputs the user ID and the password. In FIG. 23, an simplified diagnosis select button and a detailed diagnosis select button are provided to allow the user to select either the detailed diagnosis program or the free, simplified diagnosis program which demonstrates the ability and overview of the consultation system embodying the company diagnosis system of the present invention to the user and enables self-evolutional improvement of the diagnostic data. If the user has been authenticated by the user ID and the password, the company diagnosis system of the present invention proceeds to the next step when the simplified diagnosis select button or the detailed diagnosis select button in FIG. 23 is clicked.

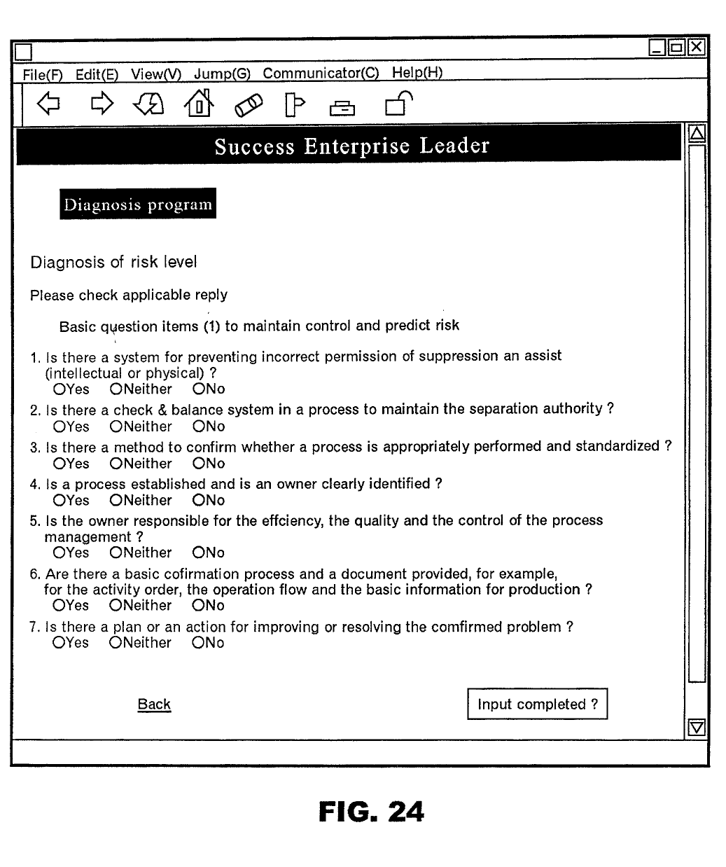

FIG. 24 illustrates exemplary question items displayed on the web page for a user who clicked the simplified diagnosis select button. As shown in FIG. 24, the question items for the simplified diagnosis may be prepared to perform a diagnosis for a single category, for example, category K=risk level. While the question items QA shown in FIG. 24 are those which are classified into the basic question item (1) for maintaining control and predicting risk, such classification may not be disclosed to the user when the question items are displayed. While shown in FIG. 24 is the embodiment for judging a risk level, the same scheme may be used for the question items belonging to the other categories. The user replies to the question items by clicking one of three check boxes “yes”, “no” and “neither”. FIG. 24 also shows that a question number is given to each question items. However, these question numbers may not be displayed to the user.

When the user has replied to all the question items, confirmed these replies, and clicked an “input completed?” button on the display screen, the replies to the question items are transmitted as reply data to the company diagnosis server 3. Then, the company diagnosis server 3 uses the database DB1 to change the reply data to numerical data following the server process of the present invention, processes the replies by using the diagnostic data stored in the database DB2 to obtain the processed reply data, and displays the processed reply data on the screen, in a form that is easy to see, as diagnostic results.

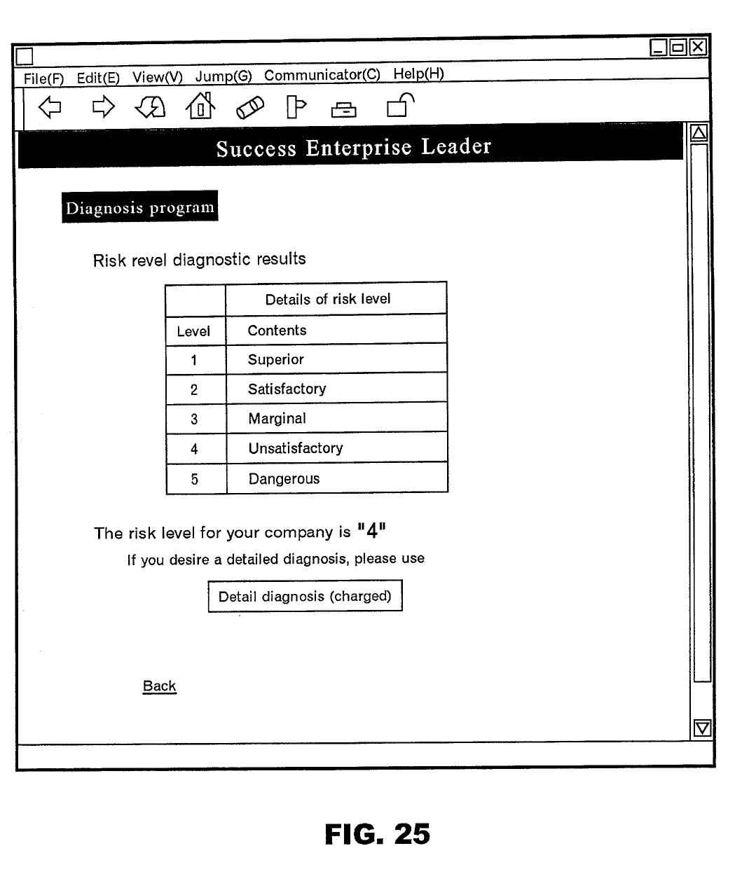

FIG. 25 illustrates a display screen on which the diagnostic results are presented to the user through the web page. On the display screen shown in FIG. 25, a risk level is displayed in absolute scale which is obtained by the absolute evaluation of the diagnostic results from the simplified diagnosis, together with the explanation of each risk level. In the embodiment shown in FIG. 25, the user's company is evaluated as risk level “4” which means “unsatisfactory”. The display screen shown in FIG. 25 further includes a “detailed diagnosis” button which enables a screen for the detailed diagnosis to be displayed immediately when the user desires the detailed diagnosis after considering the results of the simplified diagnosis.

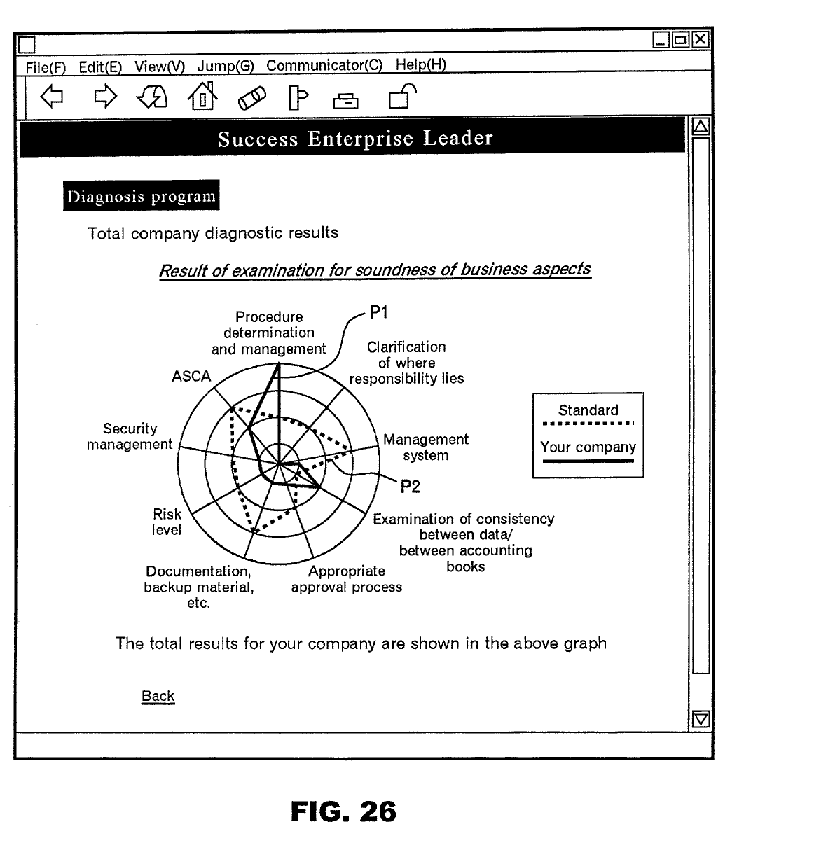

FIG. 26 illustrates a web page screen on which aggregated diagnostic results of the detailed diagnosis are graphically displayed after completion of the detailed diagnosis which the user desired and requested by clicking the “detailed diagnosis” button in FIG. 23. According to the diagnostic results shown in FIG. 26, a plot P1 indicates the reliability of the user's company in which an average level “3” is presented for establishment of procedures and maintenance/management while the highest or dangerous level “5” is presented for clarification of responsibility. In addition, a plot P2, which represents aggregated diagnostic results of standard or reference companies having the same company profile as the user's company and ranked higher, is overlapped on the graph so that the user's company can be compared with higher ranked companies having the same company profile. If the user desires a visiting consultation with a consulting staff, considering the results of the detailed diagnosis shown in FIG. 26, the user may request, using the “client corner” shown in FIG. 19, dispatch of the consulting staff. Further, in the present invention, once the approval of the user has been obtained, a comparison of the user's company with other companies in the same or different industry may be displayed using a graph or a table, or as a simulation.

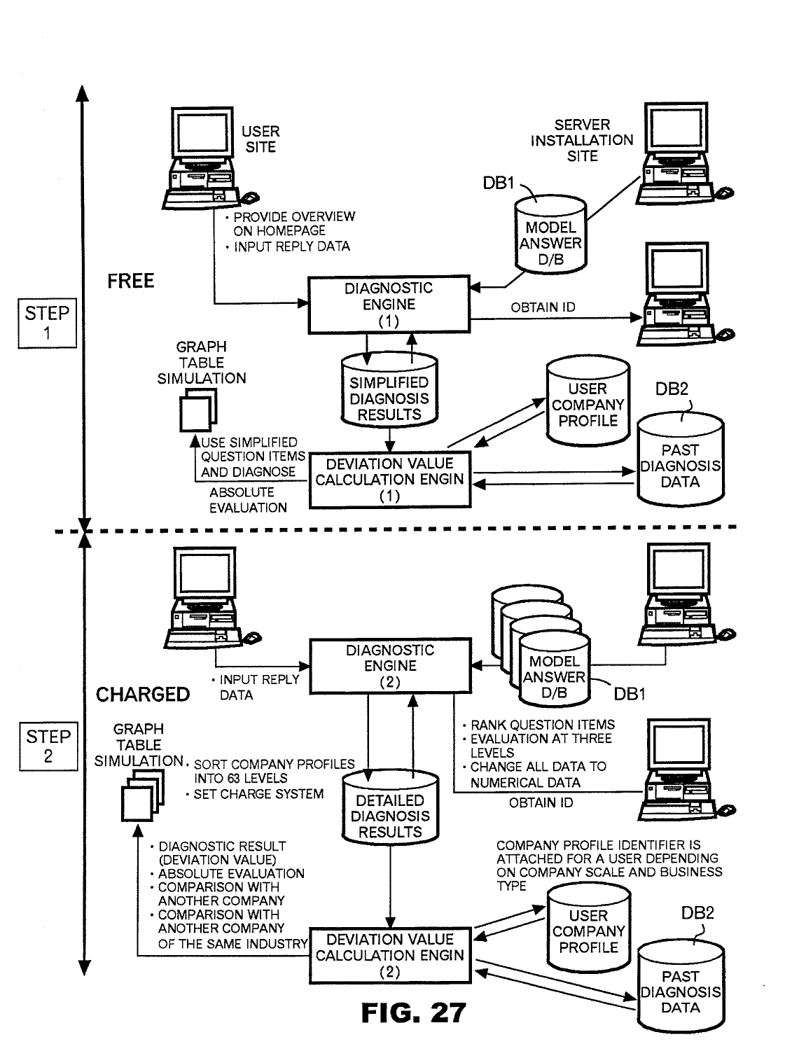

FIG. 27 illustrates a detailed process in which the company diagnosis system of the present invention is used as a system for providing consultation information. Question items for which model replies can be expected are stored in a database DB1 at a server site. A user accesses the company diagnosis system and, for example, clicks the simplified diagnosis select button on the screen in FIG. 23 to enable the free, simplified diagnosis (step 1). The user may proceed to the charged, detailed diagnosis by clicking the detailed diagnosis select button on the screen in FIG. 23 when the user has determined that the detailed diagnosis is necessary after examining the diagnostic results of the simplified diagnosis (step 2). Of course, the user may skip the free, simplified diagnosis and immediately select the charged, detailed diagnosis. When the user has determined that a consultation is necessary, as a result of the simplified and/or detailed diagnoses, the user may issue an inquiry through, for example, the “client corner” on the web page. Upon receiving such an inquiry, the server installation side may give advice on, for example, a temporary estimate. Then, if the user desires to consult as a result of the advice from the server installation side, a company consultant would visit the company of the user and give advice on, for example, improvement of business processes and system.

The above temporary estimate may also be made for the detailed diagnosis. When the user desires the detailed diagnosis based on the results of the simplified diagnosis and the advice from the server installation side, the user may select the detailed diagnosis and have the user's case diagnosed through the web page. The results of the detailed diagnosis are returned to the user through the web page, and the user may request a visiting consultation from the “client corner” if the user has determined that the consultation is necessary.

Upon receiving the request for the visiting consultation, the server installation site selects a person in charge of the consultation, or consultant, who will then present solutions and propose measures to be taken to improve business processes and system, to the user with charge. Since the objective analysis has already been completed by the questionnaire, it is possible for the consultant to provide accurate proposals promptly. This enables the user to promptly and objectively take action on increasing the reliability of the company. According to the present invention, it is possible to considerably expand the opportunities of consultation business by using the above described business procedures.

While the preferred embodiments of the invention have been described with reference to the drawings, the present invention may also include a storage medium on which a computer-readable server process program for implementing the company diagnosis method of the present invention is stored. The computer-readable program for the server process may be written in any known programming language, such as object-oriented C language. The computer-readable program may be stored on a magnetic recording medium such as a floppy disk, a hard disk or a magnetic tape, or an optical recording medium such as a CD-ROM, a DVD or a magneto-optical disk. Furthermore, since the computer-readable program may be transmitted over a network, the storage medium may also be a transmission medium.

While the preferred embodiments of the invention have been explained with reference to the drawings, the present invention is not limited thereto, and may be applied to any known company diagnosis system and company diagnosis method so long as value-added information can be provided using a self-evolutional database. Furthermore, the data structures used in the present invention need not be built in advance as those shown in the drawings, and the same results may be obtained by using a function for selecting data from the database, resulting in the data structure shown in the drawings. Also, for the detailed structure of the database, the details of the diagnosis process, and the access procedures, any known structure, process and procedures may be used as long as the advantages of the present invention are obtained.

[Description of the Symbols]

1: Network

2: Computer

3: Company diagnosis server

DB1: Database

DB2: Database

QA: Questionnaire subject matter

MA: Management level

Pr: Company profile

What is claimed

1. A company diagnosis system comprising:
means for having a questionnaire being displayed via a network;
means for receiving a reply to said questionnaire via said network;
means for processing said received reply to the questionnaire using data stored in first and second databases to produce processed reply data;
means for having said processed reply data being displayed; and
means for updating said second database by storing said processed reply data in said second database.

2. The company diagnosis system according to claim 1, wherein said questionnaire is stored in said first database, and, in order to update said second database, processed reply data obtained by processing a reply to a free questionnaire that is a part of said questionnaire stored in said first database, or processed reply data obtained by processing a reply to a charged questionnaire that includes all question items of said questionnaire stored in said first database are stored in said second database.

3. The company diagnosis system according to claim 1 or 2, wherein said reply to said questionnaire is changed to numerical data using the data in said first database, and said numerical data are ranked using the data stored in said second database to obtain said processed reply data.

4. The company diagnosis system according to one of claims 1 to 3, wherein said first database further stores point data associated said reply to said questionnaire.

5. The company diagnosis system according to one of claims 1 to 4, wherein question items in said questionnaire are sorted into categories of company reliability, and said system further comprises means for selecting and accumulating, for each category of said company reliability, the point data corresponding to replies to said question items.

6. The company diagnosis system according to one of claims 1 to 5, wherein said processed reply data constitute consultation information concerning company reliability.

7. A company diagnosis server comprising:
means for having a questionnaire being displayed via a network;
means for receiving a reply to said questionnaire via said network;
means for processing said received reply to the questionnaire using data stored in first and second databases to produce processed reply data;
means for having said processed reply data being displayed; and
means for updating said second database by storing said processed reply data in said second database.

8. The company diagnosis server according to claim 7, wherein said questionnaire is stored in said first database, and said means for updating said second database stores, in said second database, processed reply data obtained by processing a reply to a free questionnaire that is a part of said questionnaire stored in said first database, or processed reply data obtained by processing a reply to a charged questionnaire that includes all question items of said questionnaire stored in said first database.

9. The company diagnosis server according to claim 7 or 8, wherein said processing means includes means for changing said reply to said questionnaire to numerical data using the data in said first database, and means for ranking said numerical data using the data stored in said second database to obtain said processed reply data.

10. The company diagnosis server according to one of claims 7 to 9, wherein said first database further stores point data associated said reply to said questionnaire, question items in said questionnaire are sorted into categories of company reliability, and said server further comprises means for selecting and accumulating, for each category of said company reliability, the point data corresponding to replies to said question items.

11. The company diagnosis server according to one of claims 7 to 10, wherein said processed reply data constitute consultation information concerning company reliability.

12. A company diagnosis method comprising the steps of:
having a questionnaire being displayed via a network;
receiving a reply to said questionnaire via said network;
processing said received reply to the questionnaire using data stored in first and second databases to produce processed reply data;
having said processed reply data being displayed; and
updating said second database by storing said processed reply data in said second database.

13. The company diagnosis method according to claim 12, wherein said questionnaire is stored in said first database, and said step of updating said second database includes the step of storing, in said second database, processed reply data obtained by processing a reply to a free questionnaire that is a part of said questionnaire stored in said first database, or processed reply data obtained by processing a reply to a charged questionnaire that includes all question items of said questionnaire stored in said first database.

14. The company diagnosis method according to claim 12 or 13, wherein said processing step includes the steps of changing said reply to said questionnaire to numerical data using the data in said first database, and ranking said numerical data using the data stored in said second database to obtain said processed reply data.

15. The company diagnosis method according to one of claims 12 to 14, wherein said first database further stores point data associated said reply to said questionnaire, question items in said questionnaire are sorted into categories of company reliability, and said method further comprises the step of selecting and accumulating, for each category of said company reliability, the point data corresponding to replies to said question items.

16. The company diagnosis method according to one of claims 12 to 15, wherein said processed reply data constitute consultation information concerning company reliability.

17. A computer-readable recording medium on which a computer-readable program is stored for use in a company diagnosis system for providing company consultation information, said computer-readable program causing a computer to execute a company diagnosis method comprising the steps of:
having a questionnaire being displayed via a network;
receiving a reply to said questionnaire via said network;
processing said received reply to the questionnaire using data stored in first and second databases to produce processed reply data;
having said processed reply data being displayed; and
updating said second database by storing said processed reply data in said second database.

18. The computer-readable recording medium according to claim 17, wherein said questionnaire is stored in said first database, and said step of updating said second database includes the step of storing, in said second database, processed reply data obtained by processing a reply to a free questionnaire that is a part of said questionnaire stored in said first database, or processed reply data obtained by processing a reply to a charged questionnaire that includes all question items of said questionnaire stored in said first database.

19. The computer-readable recording medium according to claim 17 or 18, wherein said processing step includes the steps of changing said reply to said questionnaire to numerical data using the data in said first database, and ranking said numerical data using the data stored in said second database to obtain said processed reply data.

20. The computer-readable recording medium according to one of claims 17 to 19, wherein said first database further stores point data associated with replies to question items in said questionnaire sorted into categories of company reliability, and said method further comprises the steps of selecting and accumulating, for each category of said company reliability, the point data corresponding to said replies to said question items, and having said processed reply data being displayed as consultation information concerning said company reliability.
